(19) United States
(12) Patent Application Publication
(10) Pub. No.: US 2023/0106888 A1
(43) Pub. Date: Apr. 6, 2023

(54) Systems and Methods for Biometric Based Authentication of Video Conference Participants

(71) Applicant: BI Incorporated, Boulder, CO (US)

(72) Inventors: Duke Hanson, Boulder, CO (US); Dustin Pettit, Boulder, CO (US)

(73) Assignee: BI Incorporated, Boulder, CO (US)

(21) Appl. No.: 17/834,246

(22) Filed: Jun. 7, 2022

Related U.S. Application Data
(60) Provisional application No. 63/252,996, filed on Oct. 6, 2021.

(51) Int. Cl. G06F 21/32; H04L 12/18

(52) U.S. Cl. CPC G06F 21/32; H04L 12/1822

(57) ABSTRACT

Various embodiments provide systems and method for biometric based authentication of video conference participants.

### CROSS REFERENCE TO RELATED APPLICATION

The present application claims priority to (i.e., is a non-provisional of) U.S. Pat. App. No. 63/252,996 entitled “Systems and Methods for Biometric Based Authentication of Video Conference Participants”, and filed Oct. 6, 2021 by Hanson. The entirety of each of the aforementioned references are incorporated herein by reference for all purposes.

### BACKGROUND OF THE INVENTION

Various embodiments provide systems and methods for enhanced security video conference, and more particularly to systems and method for biometric based authentication of video conference participants.

Video conferencing has been used in a number of situations to facilitate face to face meetings without incurring the costs, insecurity, and inconvenience of travel. In many situations participants in a video conference had prior in person interaction and as such it was relatively easy to discern that the person participating in the video conference is in fact who they purport to be. As globalization continues and the desire to reduce the inconvenience, insecurity, and inconvenience of travel has increased, more and more video conferences are occurring where the participants have never previously. This is increasing the possibility of imposters participating in video conferences to the potential detriment of other participants.

Thus, for at least the aforementioned reasons, there exists a need in the art for more advanced approaches, devices and systems for enhanced video conferencing.

### BRIEF SUMMARY OF THE INVENTION

Various embodiments provide systems and methods for enhanced security video conference, and more particularly to systems and method for biometric based authentication of video conference participants.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram illustrating a video conferencing system including biometric based participant authentication in accordance with various embodiments;

FIG. 1b is a block diagram of a biometric gather and identity entry, and remote interview application in accordance with some embodiments;

FIG. 1c is a block diagram of a local interview application in accordance with some embodiments;

FIG. 1d is a block diagram of a processor based system that may be used in relation to various embodiments;

FIG. 2 is a flow diagram showing a method for operating a remote interview system in accordance with some embodiments; and

FIG. 3 is a flow diagram showing a method for operating a local interview system in accordance with some embodiments.

### DETAILED DESCRIPTION OF THE INVENTION

Various embodiments provide systems and methods for enhanced security video conference, and more particularly to systems and method for biometric based authentication of video conference participants.

Some embodiments provide methods for video conferencing that include: receiving, by a processing resource, a biometric information from a first video conference participant; determining, by the processing resource, a determined identity of the first video conference participant based at least in part on the biometric information to yield an identity confirmation; and engaging, by the processing resource, a video conference between at least the first video conference participant located at a first location and a second video conference participant located at a second location based at least in part on the identity confirmation. In various instances of the aforementioned embodiments, the methods further include: requesting, by the processing resource, that the first video conference participant provide the biometric information. In some instances of the aforementioned embodiments, the biometric information includes at least one of: a voice print, a finger print, an electrocardiogram, a palm print, a height, and/or a face image.

In some instances of the aforementioned embodiments, the identity confirmation is an identity of the first video conference participant derived from the biometric information. In other instances, the methods further include: receiving, by the processing resource, an identity information from the first video conference participant; and comparing, by the processing resource, the identity information with the determined identity to yield the identity confirmation. In some such instances, the identity confirmation: indicates a verification fail when the determined identity does not match the identity information; and indicates a verification success when the determined identity matches the identity information. In various instances, engaging the video conference between at least the first video conference participant located at the first location and the second video conference participant located at the second location based at least in part on the identity confirmation includes adding the first video conference participant to the video conference upon indication of the verification success. In other instances, engaging the video conference between at least the first video conference participant located at the first location and the second video conference participant located at the second location based at least in part on the identity confirmation includes adding the first video conference participant to the video conference upon the occurrence of both: indication of the verification failure, and permission of the second video conference participant.

In some instances of the aforementioned embodiments, the methods further include receiving, by the processing resource, a location of the first video conference participant. In some such instances, the methods further include verifying, by the processing resource, that the location of the first video conference participant is an expected location of the first video conference participant.

Other embodiments provide video conferencing systems that include a processing resource and a non-transitory computer readable medium. The non-transitory computer readable medium is coupled to the processing resource, and has stored thereon instructions that when executed by the processing resource cause the processing resource to: receive a biometric information from a first video conference participant; determine a determined identity of the first video conference participant based at least in part on the biometric information to yield an identity confirmation; and engage a video conference between at least the first video conference participant located at a first location and a second video conference participant located at a second location based at least in part on the identity confirmation. In some instances of the aforementioned embodiments, the systems further include one or more of: a camera configured to provide video images of the first video conference participant; a display coupled to the processing resource; a biometric capture interface configured to receive the biometric information and provide the biometric information to the processing resource, and an identity entry interface.

Yet other embodiments provide non-transitory computer readable media having stored thereon instructions that when executed by a processing resource cause the processing resource to: receive a biometric information from a first video conference participant; determine a determined identity of the first video conference participant based at least in part on the biometric information to yield an identity confirmation; and engage a video conference between at least the first video conference participant located at a first location and a second video conference participant located at a second location based at least in part on the identity confirmation.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

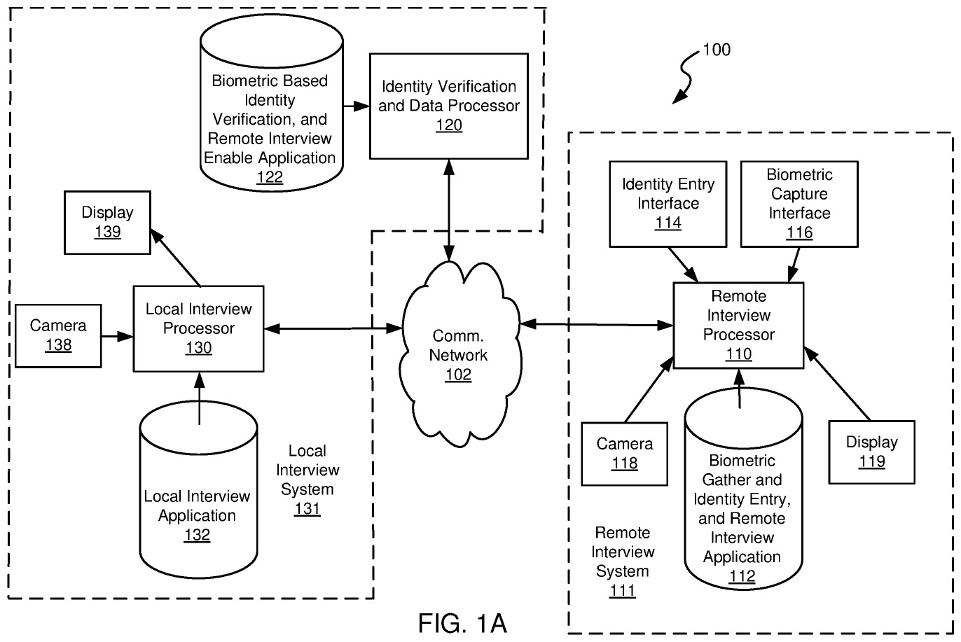

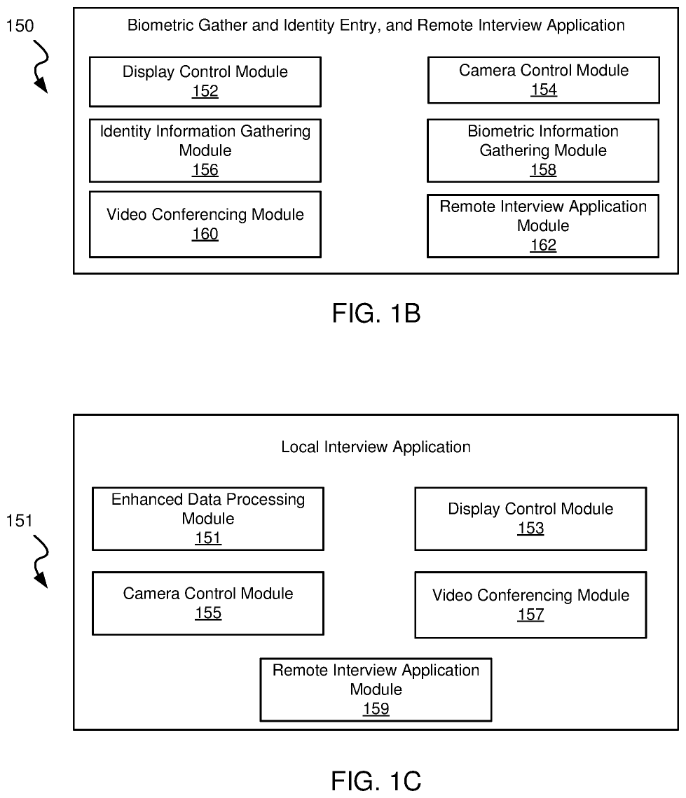

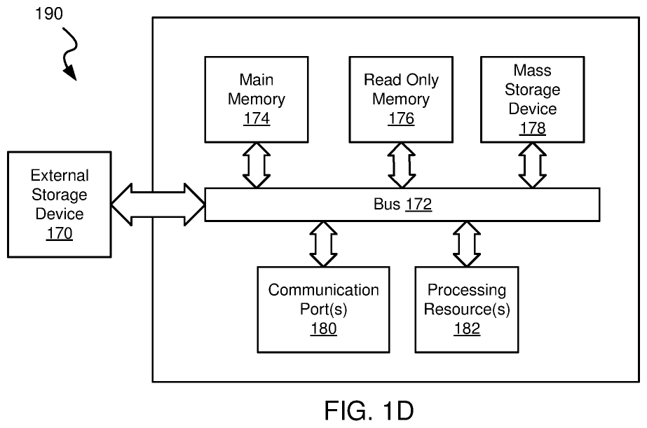

Turning to FIG. 1a, a video conferencing system 100 including biometric based participant authentication is shown in accordance with various embodiments. As shown, video conferencing system 100 includes a remote interview system 111 (shown in dashed lines) and a local interview system 131 (shown in dashed lines) each coupled via a communication network 102. Communication network 102 may be any type of communication network known in the art. Those skilled in the art will appreciate that communication network 102 can be a wireless network, a wired network or a combination thereof that can be implemented as one of the various types of networks, such as an Intranet, a Local Area Network (LAN), a Wide Area Network (WAN), an Internet, and the like. Further, secured network 101 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

Remote interview system 111 includes a remote interview processor 110. Remote interview processor 110 may be any device known in the art that includes a processing resource and sufficient input/output capability to perform the functions of receiving identity data from an identity entry interface 114, receiving biometric data from a biometric capture interface 116, receiving, processing, and/or routing video images from a camera 118, and driving a display 119. In some embodiments, remote interview processor 111 is a mobile computer. Based upon the disclosure provided herein, one of ordinary skill in the art will recognize a variety of devices and/or systems that may be used as remote interview processor 110.

Remote interview processor 110 is coupled to identity entry interface 114, biometric capture interface 116, camera 118, and display 119. In addition, remote interview processor 110 is coupled to a computer readable medium 112 that includes a biometric gather, identity entry, and remote interview application executable by a processing resource of remote interview processor 110. Identity entry interface 114 is configured to receive an alleged identity of one or more persons engaging in the conference call. In some embodiments, biometric capture interface 116 is a finger print scanner. Based upon the disclosure provided herein, one of ordinary skill in the art will recognize a variety of devices and/or combinations of devices that may be used as biometric capture interface 118 that is capable of acquiring one or more biometric data including, but not limited to, a voice print, a finger print, an electrocardiogram, a palm print, a height, and/or a face image. In some embodiments, identity entry interface 114 is a computer keyboard. In other embodiments, identity entry interface 114 is an identification document scanner. Based upon the disclosure provided herein, one of ordinary skill in the art will recognize a variety of devices and/or combinations of devices that may be used as identity entry interface 114. Camera 118 may be any device known in the art that is capable of capturing video images and transferring the captured video images to remote interview processor 110. Based upon the disclosure provided herein, one of ordinary skill in the art will recognize a variety of devices and/or combinations of devices that may be used as camera 118. Display 119 may be any device known in the art that is capable of displaying video and/or still images received from remote interview processor 110. Based upon the disclosure provided herein, one of ordinary skill in the art will recognize a variety of devices and/or combinations of devices that may be used as display 119.

Local interview system 131 includes a local interview processor 130. Local interview processor 130 may be any device known in the art that includes a processing resource and sufficient input/output capability to perform the functions of receiving, processing, and/or routing video images from a camera 138, and driving a display 139. In some embodiments, local interview processor 131 is a mobile computer. Based upon the disclosure provided herein, one of ordinary skill in the art will recognize a variety of devices and/or systems that may be used as remote interview processor 110.

In addition, local interview system 131 includes an identity verification and data processor 120. Identity verification and data processor 120 is coupled to local interview processor 130 via communication network 102. Identity verification and data processor 120 may be any device known in the art that includes a processing resource capable of performing biometric based identity verification. In some embodiments, identity verification and data processor 120 is a network application processor. Based upon the disclosure provided herein, one of ordinary skill in the art will recognize a variety of devices and/or systems that may be used as identity verification and data processor 120. Identity verification and data processor 120 is coupled to a computer readable medium 122 that includes a biometric based identity verification, and remote interview enable application executable by a processing resource of identity verification and data processor 120.

Local interview processor 130 is coupled to camera 138 and display 139. In addition, local interview processor 130 is coupled to a computer readable medium 132 that includes a local interview application executable by a processing resource of local interview processor 130. Camera 138 may be any device known in the art that is capable of capturing video images and transferring the captured video images to local interview processor 130. Based upon the disclosure provided herein, one of ordinary skill in the art will recognize a variety of devices and/or combinations of devices that may be used as camera 138. Display 139 may be any device known in the art that is capable of displaying video and/or still images received from local interview processor 130. Based upon the disclosure provided herein, one of ordinary skill in the art will recognize a variety of devices and/or combinations of devices that may be used as display 139.

Turning to FIG. 1b, a block diagram a biometric gather and identity entry, and remote interview application 150 is shown in accordance with some embodiments. As shown, biometric gather and identity entry, and remote interview application 150 includes: a display control module 152, a camera control module 154, an identity information gathering module 156, a biometric information gathering module 158, a video conferencing module 160, and a remote interview application module 162.

Display control module 152 is executable by remote interview processor 110 and configured to control information, video, and messages that are displayed via display 119. As such, display control module 152 receives information for display from other modules in biometric gather and identity entry, and remote interview application 150. Camera control module 154 is executable by remote interview processor 110 and configured to control camera 118 and receive video images from camera 118. Such control of camera 118 may include, but is not limited to, enabling and disabling camera 118, and/or adjusting various parameters related to the video images collected by camera 118. Further, receiving video images from camera 118 includes allocating either temporary or long term storage for the video images received from camera 118.

Identity information gathering module 156 is executable by remote interview processor 110 and configured to control biometric capture interface 116 and receive biometric information from biometric capture interface 116. Such control of camera 118 may include, but is not limited to, enabling and biometric capture interface 116, and/or adjusting various parameters related to the capture of biometric information via biometric capture interface 116. Further, receiving biometric information from biometric capture interface 116 includes allocating either temporary or long term storage for the biometric information received from biometric capture interface 116. Identity information gathering module 156 is executable by remote interview processor 110 and configured to receive identity information from identity entry interface 114. Receiving identity information from identity entry interface 114includes allocating either temporary or long term storage for the identity information received from identity entry interface 114.

Video conferencing module 160 is executable by remote interview processor 110 and configured to perform video conferencing with one or more other devices engaged in a particular video conference. As such, video conferencing module 160 is configured to perform a variety of video conference processes including, but not limited to, transferring video images (including sound) gathered by camera 118 to other end point devices (or a central video conferencing system—not shown) as is known in the art, controlling sound levels and video image parameters as is known in the art, receiving video images (including sound) gathered by camera 118 to other end point devices (or a central video conferencing system—not shown) as is known in the art. Based upon the disclosure provided herein, one of ordinary skill in the art will recognize a variety of video conferencing processes that may be provided via video conferencing module 160 in accordance with different embodiments.

Remote interview application module 162 is executable by remote interview processor 110 and configured to govern the interaction of biometric gather and identity entry, and remote interview application 150 includes: display control module 152, camera control module 154, identity information gathering module 156, biometric information gathering module 158, and video conferencing module 160. In one embodiment, remote interview application module 162 determines whether there is an indication that a video conference is starting. The indication can be, for example, an indication that a host has joined the video conference, a calendar reminder of a pre-scheduled video conference, or an indication that the individual operating the local interview system is ready to start. Based upon the disclosure provided herein, one of ordinary skill in the art will recognize a variety of indicators of the start of a video conference that may be used in relation to different embodiments.

Where an indication of the start of a video conference has been received or otherwise detected, remote interview application module 162 notifies remote individuals of the start of the video conference by causing display control module 152 to generate a notification message to display 119. In addition, remote interview application module 162 notifies remote individuals to input identification information via identity entry interface 114 and biometric information via biometric capture interface 116. As part of this information gathering process, remote interview application module 162 causes identity information gathering module 156 to enable and gather information, and biometric information gathering module 158 to enable and gather information.

In some embodiments, while the identity and biometric information is being entered, remote interview application module 162 causes camera control module 154 to engage camera 118, and video conferencing module 160 to transmit video images received via camera 118. Such an approach allows for assurance that the remote individual in the video conference is in fact the person that provided the requested information. In other embodiments, this information input may be requested prior to the start time of the video conference where the remote individuals are in an area where they can be monitored to assure that the person who provided the identification and biometric information will in fact be the person on the video conference.

For the purposes of this application, a remote individual is any individual that will be being verified using biometric information, and a local individual is any individual that is known and will not be being verified using biometric information. Based upon the disclosure provided herein, one of ordinary skill in the art will recognize a variety of processes that may be used in relation to different embodiments to notify of the start of a video conference and request input of biometric information.

After requesting that the remote individual(s) input their identification information and biometric information, remote interview application module 162 waits until the requested information is received via identity information gathering module 156 and biometric information gathering module 158. Once the information is received, remote interview application module 162 transmits the gathered information to identity verification and data processor 120. In turn, identity verification and data processor 120 executes biometric based identity verification, and remote interview enable application 122.

Biometric based identity verification, and remote interview enable application 122 performs a biometric information based identification based upon the biometric information provided from remote interview application module 162. Where for example the biometric information is a face image, biometric based identity verification, and remote interview enable application 122 first performs facial recognition in an effort to determine the identity of the individual associated with the biometric information. Any face recognition process known in the art may be used. Alternatively, or in addition, where for example the biometric information is a finger print, biometric based identity verification, and remote interview enable application 122 performs finger print recognition in an effort to determine the identity of the individual associated with the biometric information. Any finger print recognition process known in the art may be used. Based upon the disclosure provided herein, one of ordinary skill in the art will recognize a variety of biometric information that may be gathered by remote interview system 111 and processed by biometric based identity verification, and remote interview enable application 122 and corresponding processes known in the art that may be used to ascertain the identity of the individual providing the biometric information.

Biometric based identity verification, and remote interview enable application 122 then compares the identity determined using the biometric information with the identity information provided by the remote individual(s) via identity entry interface 114. Where either the biometric information does not result in an identity of the remote individual or the identity determined based upon the biometric information matches the identify indicated by the remote individual(s) via identity entry interface 114, biometric based identity verification, and remote interview enable application 122 sends a message to biometric information, remote interview application module 162 indicating an identity verification. Alternatively, where the identity determined based upon the biometric information does not match the identify indicated by the remote individual(s) via identity entry interface 114, biometric based identity verification, and remote interview enable application 122 sends a message to biometric information, remote interview application module 162 indicating a failure of identity verification.

Where the message from biometric based identity verification, and remote interview enable application 122 indicates that the received information was verified, remote interview application module 162 causes video conferencing module 160 to connect the remote individual(s) to the video conference including any other remote individual(s) and/or local individual(s). In addition, remote interview application module 162 stores the received biometric and identity information as part of a record of the video conference. Alternatively, where the message from biometric based identity verification, and remote interview enable application 122 indicates that the received information was not verified, remote interview application module 162 notifies local interview system 131 of the failure, stores the received biometric and identity information as part of a record of the video conference, and causes video conferencing module 160 to disconnect and terminate the video conference.

Alternatively, where the information is verified (block 210), the video conference is engaged between the local interview system (used by one or more local individuals) and one or more remote interview systems (used by one or more remote individuals and in some cases one or more local individuals)(block 220). In addition, the received biometric and identity information is saved as part of a record of the video conference (block 222). The video conference may continue with the connected individuals interacting until the video conference is terminated (block 224). Once the video conference is terminated (via input from one or more of local interview system and/or remote interview system)(block 224), the video conference is ended (block 226).

It is possible in some scenarios that all individuals are considered remote individuals. In such cases, there is not necessarily a local interview system and a remote interview system, but rather multiple remote interview systems that, for example, rely on a shared identity verification system. In such a system of multiple remote interview systems, each remote interview system generates its own notice to enter identification and biometric information based upon, for example, a scheduled time for a conference call. In the case of multiple remote interview systems and no local interview system, each system may be configured to wait until the information from other remote individuals is received before engaging with them in the conference call.

Turning to FIG. 1c, a block diagram of a local interview application 151 in accordance with some embodiments. As shown, local interview application 151 includes: an enhanced data processing module 151, a display control module 153, a camera control module 155, and a video conferencing module 157.

Enhanced data processing module 151 is executable by local interview processor 130 and configured to superimpose text information about one or more remote individuals over video images of the corresponding remote individuals during an ongoing video conference. The text information about one or more remote individuals is received from executes biometric based identity verification, and remote interview enable application 122, and includes data maintained about known individuals. Such text information may include, but is not limited to, employer, home address, position title, criminal record, or the like for one or more remote individuals participating in a video conference. Based upon the disclosure provided herein, one of ordinary skill in the art will recognize a variety of enhanced information which may be displayed relative to the video image of a remote individual in accordance with different embodiments.

Display control module 153 is executable by local interview processor 130 and configured to control information, video, and messages that are displayed via display 139. As such, display control module 153 receives information for display from other modules. Camera control module 155 is executable by local interview processor 130 and configured to control camera 138 and receive video images from camera 138. Such control of camera 138 may include, but is not limited to, enabling and disabling camera 138, and/or adjusting various parameters related to the video images collected by camera 138. Further, receiving video images from camera 138 includes allocating either temporary or long term storage for the video images received from camera 138.

Video conferencing module 157 is executable by local interview processor 130 and configured to perform video conferencing with one or more other devices engaged in a particular video conference. As such, video conferencing module 157 is configured to perform a variety of video conference processes including, but not limited to, transferring video images (including sound) gathered by camera 138 to other end point devices (or a central video conferencing system—not shown) as is known in the art, controlling sound levels and video image parameters as is known in the art, receiving video images (including sound) gathered by camera 138 to other end point devices (or a central video conferencing system—not shown) as is known in the art. Based upon the disclosure provided herein, one of ordinary skill in the art will recognize a variety of video conferencing processes that may be provided via video conferencing module 157 in accordance with different embodiments.

Local interview application module 159 is executable by local interview processor 130 and configured to govern the interaction of: enhanced data processing module 151, display control module 153, camera control module 155, and video conferencing module 157. In one embodiment, local interview application module 159 determines whether there is an indication that a video conference is starting. The indication can be, for example, an indication that a local individual operating local interview system 131 desires to start the conference call. Based upon the disclosure provided herein, one of ordinary skill in the art will recognize a variety of indicators of the start of a video conference that may be used in relation to different embodiments.

Where an indication of the start of a video conference has been received or otherwise detected, local interview application module 159 sends a request to start a video conference to one or more remote interview systems 111 accessible to remote individual(s). In addition, local interview application module 159 causes display control module 153 to display a message via display 139 asking a local individual if they desire a minimized mode or an enhanced mode. Minimized mode is a video conference limited to an image of the remote individual(s) on the screen. In contrast, enhanced mode is a video conference that includes an image of the remote individual(s) enhanced with text information explaining the identity and any other relevant information (e.g., employer, home address, position title, criminal record, or the like) relative the image of the respective individual on the screen. Where enhanced mode is selected, local interview application module 159 causes enhanced data processing module 151 to augment the video display with available text information.

Local interview application module 159 determines whether verification of the remote individual(s) has been received from biometric based identity verification, and remote interview enable application 122. Once the results of the verification process have been received, local interview application module 159 determines whether the verification of the identity of the remote individual(s) succeeded (i.e., biometric information matched the expected identity of the remote individual) or failed (i.e., biometric information did not match the expected identity of the remote individual). Where the verification failed, local interview application module 159 determines whether the local individual wishes to proceed. This determination may be made, for example, by querying the local individual by causing display control module 153 to display a query message via display 139. Where either the verification failed and the local individual does wish to proceed or the verification succeeded, local interview application module 159 causes video conferencing module 157 to engage the video conference between local interview system 131 (used by one or more local individuals) and one or more remote interview systems 111 (used by one or more remote individuals and in some cases one or more local individuals). The video conference may continue with the connected individuals interacting until the video conference is terminated. Once the video conference is terminated (via input from one or more of local interview system and/or remote interview system), local interview application module 159 causes video conferencing module 157 to terminate the video conference. Alternatively, where the verification failed and the local individual does not wish to proceed, local interview application module 159 causes video conferencing module 157 to terminate the video conference.

Turning to FIG. 1d, a block diagram of an example processor based system 190 is shown that may be used in relation to various embodiments. As shown in FIG. 1s,processor based system 160 includes an external storage device 170, a bus 172, a main memory 174, a read-only memory 176, a mass storage device 178, one or more communication ports 180, and one or more processing resources 182. In one embodiment, processor based system 190 may represent some portion of remote interview processor 110, identity verification and data processor 120, and/or local interview processor 130. Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g. start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing resources to software system.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc-Read Only Memory (CD-ROM), Compact Disc-Rewritable (CD-RW), Digital Video Disk-Read Only Memory (DVD-ROM). Components described above are meant only to show various possibilities. In no way should the aforementioned example computer system limit the scope of the present disclosure.

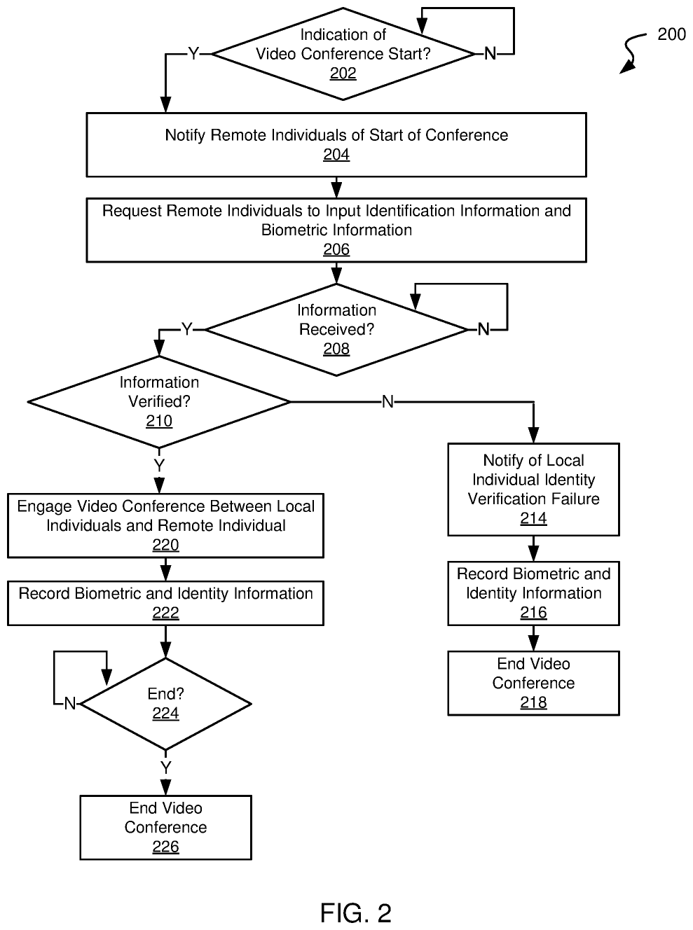

Turning to FIG. 2, a flow diagram 200 shows a method for operating a remote interview system in accordance with some embodiments. Following flow diagram 200, it is determined whether there is an indication that a video conference is starting (block 202). The indication can be, for example, an indication that a host has joined the video conference, a calendar reminder of a pre-scheduled video conference, or an indication that the individual operating the local interview system is ready to start. Based upon the disclosure provided herein, one of ordinary skill in the art will recognize a variety of indicators of the start of a video conference that may be used in relation to different embodiments.

Where an indication of the start of a video conference has been received or otherwise detected (block 202), remote individuals are notified of the start of the video conference (block 204) and requested to input their identification information and biometric information (block 206). This may be done, for example, displaying a message via a display of the remote interview system accessible to the remote individuals requesting entry of the biometric and identity information. In some embodiments, while this information is being entered, a camera of the remote interview system is engaged and transmitting video to a local interview system. This allows for assurance that the remote individual in the video conference is in fact the person that provided the requested information. In other embodiments, this information input may be requested prior to the start time of the video conference where the remote individuals are in an area where they can be monitored to assure that the person who provided the identification and biometric information will in fact be the person on the video conference.

After requesting that the remote individual(s) input their identification information and biometric information (block 206), the remote interview system waits until the requested information is received (block 208). Once the information is received (block 208), it is determined whether the received information was verified (block 210). The received information may be routed to an identity verification and data processor of a local interview system where the biometric information is processed to determine a biometric based identity of the individual that provided the information, and the biometric based identity is compared with the identity information that was entered by the remote individual. Where the information indicates the same individual, the information is considered verified (block 208). Otherwise, the information is considered unverified (block 208). Where the information is unverified, there is a strong possibility of an imposter presenting themselves as a remote individual.

Where the information is not verified (block 210), the local individual using the local interview system is notified (block 214). This notification may include, for example, sending a message to the local interview system that causes a message to display via a display of the local interview system. The received biometric and identity information is saved as part of a record of the video conference (block 216), and the video conference is terminated (block 218).

Alternatively, where the information is verified (block 210), the video conference is engaged between the local interview system (used by one or more local individuals) and one or more remote interview systems (used by one or more remote individuals and in some cases one or more local individuals)(block 220). In addition, the received biometric and identity information is saved as part of a record of the video conference (block 222). The video conference may continue with the connected individuals interacting until the video conference is terminated (block 224). Once the video conference is terminated (via input from one or more of local interview system and/or remote interview system)(block 224), the video conference is ended (block 226).

It is possible in some scenarios that all individuals are considered remote individuals. In such cases, there is not necessarily a local interview system and a remote interview system, but rather multiple remote interview systems that, for example, rely on a shared identity verification system. In such a system of multiple remote interview systems, each remote interview system generates its own notice to enter identification and biometric information based upon, for example, a scheduled time for a conference call. In the case of multiple remote interview systems and no local interview system, each system may be configured to wait until the information from other remote individuals is received before engaging with them in the conference call.

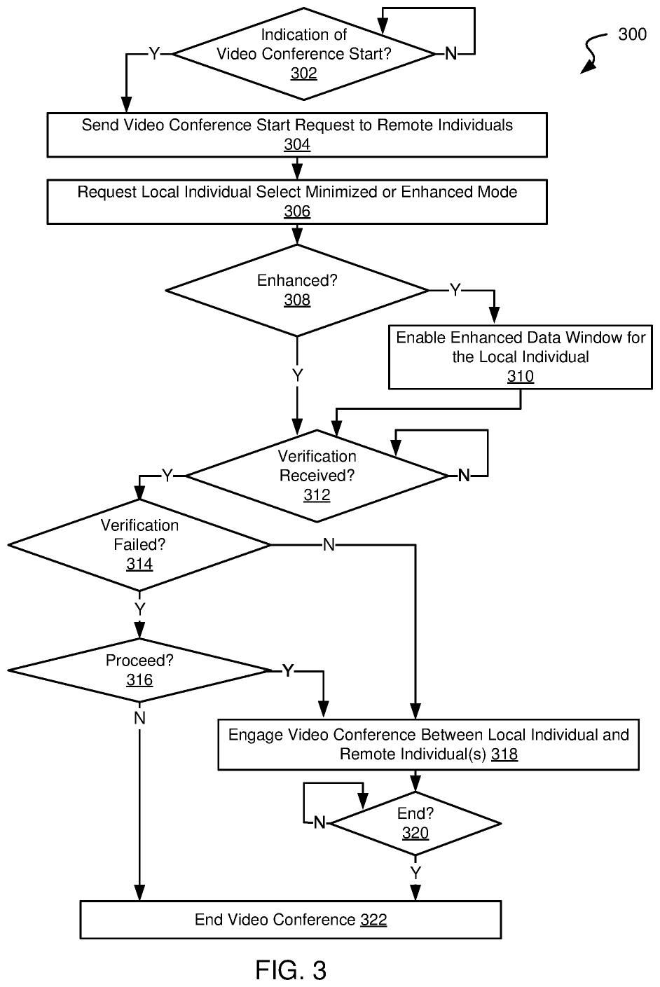

Turning to FIG. 3, a flow diagram 300 shows a method for operating a local interview system in accordance with some embodiments. Following flow diagram 300, it is determined whether there is an indication that a video conference is starting (block 302). The indication can be, for example, an indication that a local individual operating the local interview system desires to start the conference call. Based upon the disclosure provided herein, one of ordinary skill in the art will recognize a variety of indicators of the start of a video conference that may be used in relation to different embodiments.

Where an indication of the start of a video conference has been received or otherwise detected (block 302), a request to start a video conference is sent to one or more remote interview systems accessible to remote individual(s) (block 304). As an example, this may constitute the indication of a video conference start discussed above in relation to block 202 of FIG. 2. In addition, the local individual is requested to indicate whether they desire minimized or enhanced mode (block 306). This may be done, for example, by displaying a message to a display associated with the local interview system. Minimized mode is a video conference limited to an image of the remote individual(s) on the screen. In contrast, enhanced mode is a video conference that includes an image of the remote individual(s) enhanced with text information explaining the identity and any other relevant information (e.g., employer, home address, position title, criminal record, or the like) relative the image of the respective individual on the screen. The enhanced information may be provided, for example, by an identity verification and data processor associated with the local interview system. Where the local individual selects enhanced mode (block 308), an enhanced data window is enabled for the local individual (block 310).

It is determined whether verification of the remote individual(s) has been received (block 312). This may be, for example, waiting until the processes of block 210 of FIG. 2 have completed. Once the results of the verification process have been received (block 312), it is determined whether the verification of the identity of the remote individual(s) succeeded (i.e., biometric information matched the expected identity of the remote individual) or failed (i.e., biometric information did not match the expected identity of the remote individual).

Where the verification failed (block 314), it is determined whether the local individual wishes to proceed (block 316). This determination may be made, for example, by querying the local individual. Where either the verification failed (block 314) and the local individual does wish to proceed (block 316) or the verification succeeded (block 314), the video conference is engaged between the local interview system (used by one or more local individuals) and one or more remote interview systems (used by one or more remote individuals and in some cases one or more local individuals) (block 318). The video conference may continue with the connected individuals interacting until the video conference is terminated (block 320). Once the video conference is terminated (via input from one or more of local interview system and/or remote interview system)(block 320), the video conference is ended (block 322). Alternatively, where the verification failed (block 314) and the local individual does not wish to proceed (block 316), the video conference is ended (block 322).

In conclusion, the present invention provides for novel systems, devices, and methods for enhanced video conference security. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for video conferencing, the method comprising:
receiving, by a processing resource, a biometric information from a first video conference participant;
determining, by the processing resource, a determined identity of the first video conference participant based at least in part on the biometric information to yield an identity confirmation; and
engaging, by the processing resource, a video conference between at least the first video conference participant located at a first location and a second video conference participant located at a second location based at least in part on the identity confirmation.

2. The method of claim 1, wherein the identity confirmation is an identity of the first video conference participant derived from the biometric information.

3. The method of claim 1, the method further comprising:
receiving, by the processing resource, an identity information from the first video conference participant; and
comparing, by the processing resource, the identity information with the determined identity to yield the identity confirmation.

4. The method of claim 3, wherein the identity confirmation:
indicates a verification fail when the determined identity does not match the identity information; and
indicates a verification success when the determined identity matches the identity information.

5. The method of claim 4, wherein engaging the video conference between at least the first video conference participant located at the first location and the second video conference participant located at the second location based at least in part on the identity confirmation includes:
adding the first video conference participant to the video conference upon indication of the verification success.

6. The method of claim 4, wherein engaging the video conference between at least the first video conference participant located at the first location and the second video conference participant located at the second location based at least in part on the identity confirmation includes:
adding the first video conference participant to the video conference upon the occurrence of both: indication of the verification failure, and permission of the second video conference participant.

7. The method of claim 1, wherein the method further comprises:
requesting, by the processing resource, that the first video conference participant provide the biometric information.

8. The method of claim 1, wherein the biometric information includes at least one data selected from a group consisting of: a voice print, a finger print, an electrocardiogram, a palm print, a height, and a face image.

9. The method of claim 1, the method further comprising:
receiving, by the processing resource, a location of the first video conference participant.

10. The method of claim 9, the method further comprising:
verifying, by the processing resource, that the location of the first video conference participant is an expected location of the first video conference participant.

11. A video conferencing system, the system comprising:
a processing resource and a non-transitory computer readable medium coupled to the processing resource, wherein the non-transitory computer readable medium has stored thereon instructions that when executed by the processing resource cause the processing resource to:
receive a biometric information from a first video conference participant;
determine a determined identity of the first video conference participant based at least in part on the biometric information to yield an identity confirmation; and
engage a video conference between at least the first video conference participant located at a first location and a second video conference participant located at a second location based at least in part on the identity confirmation.

12. The system of claim 11, wherein the identity confirmation is an identity of the first video conference participant derived from the biometric information.

13. The system of claim 11, wherein the non-transitory computer readable medium further has stored thereon instructions that when executed by the processing resource cause the processing resource to:
receive an identity information from the first video conference participant;
compare the identity information with the determined identity to yield the identity confirmation.

14. The system of claim 13, wherein the identity confirmation:
indicates a verification fail when the determined identity does not match the identity information; and
indicates a verification success when the determined identity matches the identity information.

15. The system of claim 14, wherein engaging the video conference between at least the first video conference participant located at the first location and the second video conference participant located at the second location based at least in part on the identity confirmation includes:
adding the first video conference participant to the video conference upon indication of the verification success.

16. The system of claim 14, wherein engaging the video conference between at least the first video conference participant located at the first location and the second video conference participant located at the second location based at least in part on the identity confirmation includes:
adding the first video conference participant to the video conference upon the occurrence of both: indication of the verification failure, and permission of the second video conference participant.

17. The system of claim 13, the system further comprising:
a camera configured to provide video images of the first video conference participant;
a display coupled to the processing resource;
a biometric capture interface configured to receive the biometric information and provide the biometric information to the processing resource; and
an identity entry interface configured to receive the identity information and provide the identity information to the processing resource.

18. The system of claim 11, wherein the non-transitory computer readable medium further has stored thereon instructions that when executed by the processing resource cause the processing resource to:
request that the first video conference participant provide the biometric information.

19. The system of claim 11, wherein the biometric information includes at least one data selected from a group consisting of: a voice print, a finger print, an electrocardiogram, a palm print, a height, and a face image.

20. The system of claim 11, the system further comprising:
a camera configured to provide video images of the first video conference participant;
a display coupled to the processing resource; and
a biometric capture interface configured to receive the biometric information and provide the biometric information to the processing resource.

21. A non-transitory computer readable medium, wherein the non-transitory computer readable medium has stored thereon instructions that when executed by a processing resource cause the processing resource to:
receive a biometric information from a first video conference participant;
determine a determined identity of the first video conference participant based at least in part on the biometric information to yield an identity confirmation; and
engage a video conference between at least the first video conference participant located at a first location and a second video conference participant located at a second location based at least in part on the identity confirmation.

22. The non-transitory computer readable medium of claim 21, wherein the biometric information includes at least one data selected from a group consisting of: a voice print, a finger print, an electrocardiogram, a palm print, a height, and a face image.
